(19) United States
(12) Patent Application Publication
(10) Pub. No.: US 2024/0386392 A1
(43) Pub. Date: Nov. 21, 2024

(54) INFORMATION PROCESSING APPARATUS AND INFORMATION PROCESSING SYSTEM

(71) Applicant: SUBARU CORPORATION, Tokyo (JP)

(72) Inventor: Hideaki KATO, Tokyo (JP)

(73) Assignee: SUBARU CORPORATION, Tokyo (JP)

(21) Appl. No.: 18/650,749

(22) Filed: Apr. 30, 2024

(30) Foreign Application Priority Data
May 15, 2023 (JP) 2023-080352

(51) Int. Cl. G06Q 10/20; G06Q 20/10; G06Q 30/0283

(52) U.S. Cl. CPC G06Q 10/20; G06Q 20/102; G06Q 30/0283

(57) ABSTRACT

An information processing apparatus includes a processor(s), and a storage medium on which a program executed by the processor(s) is stored. The program includes an instruction(s) causing the processor(s) to execute: obtaining charging cost information sets pertaining to charging on-board batteries of vehicles; receiving a rescue request from a malfunctioning vehicle in which a malfunction has occurred; extracting, based on rescue content pertaining to resolving the malfunction and battery levels of the on-board batteries of the vehicles, a vehicle(s) capable of resolving the malfunction as a potential rescue vehicle(s); calculating a reward based on the rescue content and the charging cost information set(s) for each potential rescue vehicle; presenting each potential rescue vehicle and the reward to a user of the malfunctioning vehicle; identifying a vehicle selected by the user of the malfunctioning vehicle as a rescue vehicle; and notifying a user of the rescue vehicle of a rescue request.

### CROSS-REFERENCE TO RELATED APPLICATIONS

The present application claims priority from Japanese Patent Application No. 2023-080352 filed on May 15, 2023, the entire contents of which are hereby incorporated by reference.

### BACKGROUND

The disclosure relates to the technical field of an information processing apparatus and an information processing system for resolving malfunctions occurring in vehicles.

Electric vehicles that can travel without using fuel such as gasoline have become increasingly popular. Electric vehicles are configured to travel by converting electric power charged in their on-board batteries into motive power. Because charging facilities for on-board batteries are less widespread than gas stations, electric vehicles are prone to malfunctions due to the lack of electric power.

Japanese Unexamined Patent Application Publication (JP-A) No. 2022-139845 describes techniques for making a rescue request to a vehicle capable of providing rescue to an electrically depleted vehicle and presenting a reward to be paid to the rescuer.

### SUMMARY

An aspect of the disclosure provides an information processing apparatus. The information processing apparatus includes one or more processors and a storage medium on which a program to be executed by the one or more processors is stored. The program includes one or more instructions, the one or more instructions causing the one or more processors to execute: obtaining charging cost information sets pertaining to charging on-board batteries of vehicles; receiving a rescue request from a malfunctioning vehicle in which a malfunction has occurred; extracting, based on rescue content pertaining to resolving the malfunction and battery levels of the on-board batteries of the vehicles, one or more vehicles capable of resolving the malfunction as one or more potential rescue vehicles from among the vehicles; calculating a reward based on the rescue content and corresponding one or more of the charging cost information sets for each of the one or more potential rescue vehicles; presenting each of the one or more potential rescue vehicles and the reward to a user of the malfunctioning vehicle; identifying a vehicle selected by the user of the malfunctioning vehicle from among the one or more potential rescue vehicles as a rescue vehicle; and notifying a user of the rescue vehicle of a rescue request.

An aspect of the disclosure provides an information processing system. The information processing system includes a first information processing apparatus on a server side, and a second information processing apparatus associated with a vehicle. The first information processing apparatus includes one or more first processors and a first storage medium on which a first program to be executed by the one or more first processors is stored. The first program includes one or more first instructions. The one or more first instructions cause the one or more first processors to execute: obtaining, from the second information processing apparatus, charging cost information sets pertaining to charging on-board batteries of vehicles; receiving a rescue request from a malfunctioning vehicle in which a malfunction has occurred; extracting, based on rescue content pertaining to resolving the malfunction and battery levels of the on-board batteries of the vehicles, one or more vehicles capable of resolving the malfunction as one or more potential rescue vehicles from among the vehicles; calculating a reward based on the rescue content and corresponding one or more of the charging cost information sets for each of the one or more potential rescue vehicles; presenting each of the one or more potential rescue vehicles and the reward to a user of the malfunctioning vehicle; identifying a vehicle selected by the user of the malfunctioning vehicle from among the one or more potential rescue vehicles as a rescue vehicle; and notifying a user of the rescue vehicle of a rescue request. The second information processing apparatus includes one or more second processors and a second storage medium on which a second program to be executed by the one or more second processors is stored. The second program includes one or more second instructions. The one or more second instructions cause the one or more second processors to execute: transmitting the charging cost information pertaining to charging the on-board battery of the associated vehicle to the first information processing apparatus; determining whether a malfunction has occurred in the associated vehicle; notifying the first information processing apparatus when it is determined that the malfunction has occurred; displaying each of the one or more potential rescue vehicles extracted by the first information processing apparatus and the reward; transmitting information for identifying a vehicle selected from among the one or more potential rescue vehicles to the first information processing apparatus; receiving the rescue request from the first information processing apparatus; and performing display in accordance with reception of the rescue request.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a diagram illustrating an example of the configuration of an information processing system;

FIG. 2 is a diagram illustrating the hardware configuration of an information processing apparatus;

FIG. 3 is a diagram illustrating the hardware configuration of a vehicle;

FIG. 4 is a diagram illustrating the functional configuration of a server apparatus;

FIG. 5 is a diagram illustrating the functional configuration of a vehicle;

FIG. 6 is a flowchart illustrating an example of a process executed by the server apparatus to collect information about a vehicle;

FIG. 7 is a flowchart illustrating an example of a process executed by a vehicle to transmit information about the vehicle to the server apparatus;

FIG. 8 is a flowchart illustrating an example of a process of the sequential actions followed by FIG. 9, which is executed by the server apparatus to resolve a malfunction occurring in a malfunctioning vehicle;

FIG. 9 is a flowchart illustrating an example of a process of the sequential actions following FIG. 8, which is executed by the server apparatus to resolve a malfunction occurring in a malfunctioning vehicle;

FIG. 10 is a flowchart illustrating an example of a process of the sequential actions followed by FIG. 11, which is executed by a vehicle to resolve a malfunction occurring in a malfunctioning vehicle;

FIG. 11 is a flowchart illustrating an example of a process of the sequential actions following FIG. 10, which is executed by a vehicle to resolve a malfunction occurring in a malfunctioning vehicle; and

FIG. 12 is a diagram illustrating a modification of the configuration of the information processing system.

### DETAILED DESCRIPTION

The cost of charging on-board batteries installed in electric vehicles varies more than the cost of purchasing gasoline.

For example, electricity rates may differ between charging the on-board battery at night and charging it during the day. Furthermore, the cost of charging may differ between normal charging and quick charging.

However, in the techniques described in JP-A No. 2022-139845 mentioned above, such charging cost is not taken into account, and rescuers may end up incurring losses when rescuing malfunctioning vehicles, which may reduce their willingness to provide rescue.

It is desirable to present appropriate rewards to rescuers.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

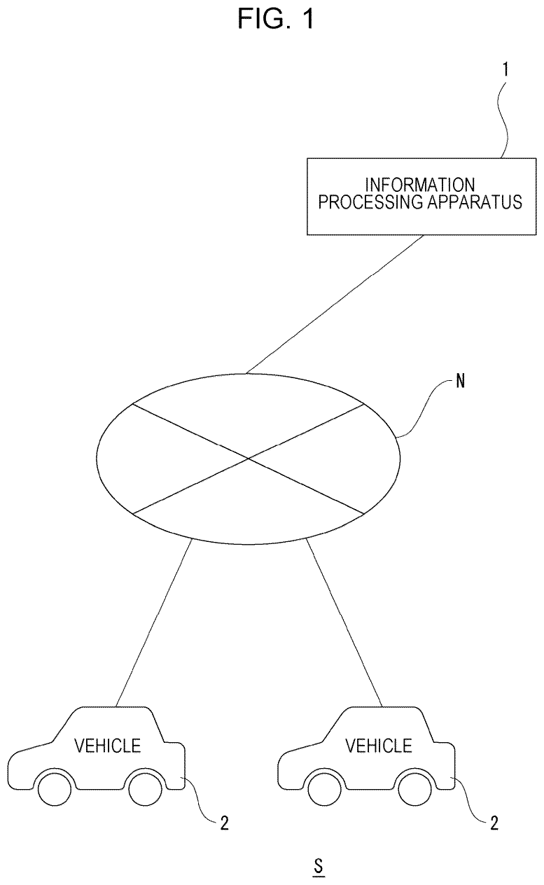

An information processing system S according to an embodiment of the disclosure is configured with a server apparatus 1 and one or more vehicles 2 (see FIG. 1).

The information processing system S is a system for resolving malfunctions occurring in the vehicles 2. In one example, the information processing system S receives a notification from a malfunctioning vehicle 2T, which is a vehicle 2 in which a malfunction has occurred, and extracts a candidate for a vehicle 2 to assist with resolving the malfunction as a potential rescue vehicle 2P. Then, the information processing system S calculates and presents a reward according to the charging cost of an on-board battery installed in the potential rescue vehicle 2P.

Note that, because examples are given using electric vehicles in the following description, terms such as “charging cost” and “energy efficiency” are used, but these are merely examples.

The vehicles 2 may include vehicles 2 equipped with an internal combustion engine, such as gasoline vehicles or diesel vehicles, as well as fuel cell vehicles that travel using hydrogen, etc. In such cases, the present configuration can be applied by replacing the terms “charging cost” with “fuel cost” and “energy efficiency” with “fuel efficiency”.

The information processing system S also identifies a vehicle selected by a user of the malfunctioning vehicle 2T from among the potential rescue vehicles 2P as a rescue vehicle 2R and sends a rescue request to the rescue vehicle 2R.

The server apparatus 1 and the vehicles 2 are configured to be able to communicate with each other via a communication network N.

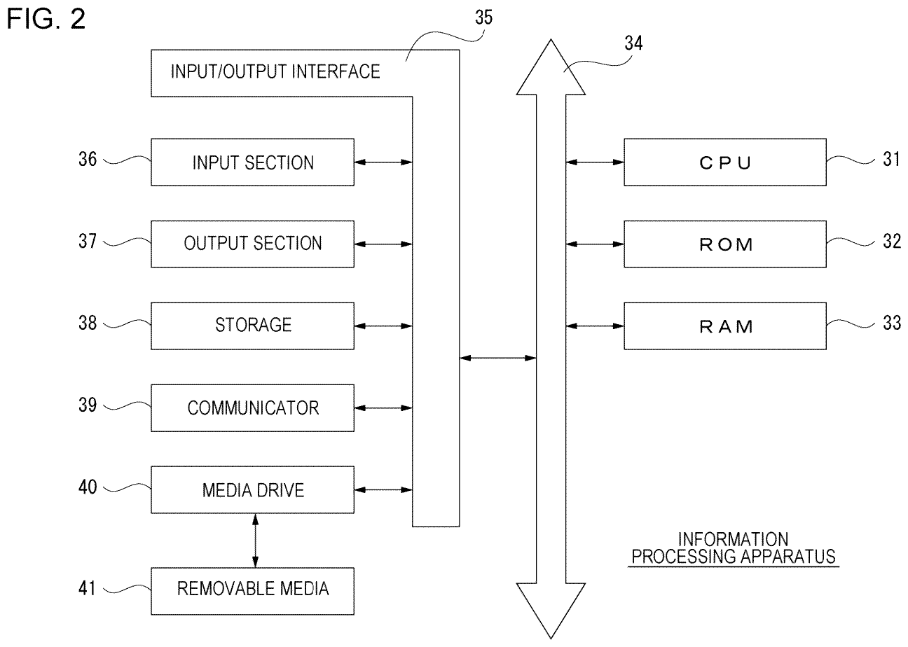

An example of the configuration the server apparatus 1 is illustrated in FIG. 2.

The server apparatus 1 is configured with a central processing unit (CPU) 31, a read only memory (ROM) 32, a random access memory (RAM) 33, a bus 34, an input/output interface 35, an input section 36, an output section 37, a storage 38, a communicator 39, a media drive 40, and the like.

The CPU 31 executes various processes according to a program stored in the ROM 32 or a program loaded from the storage 38 into the RAM 33. The RAM 33 also stores data and the like as appropriate which are necessary for the CPU 31 to execute various processes.

The CPU 31, ROM 32, and RAM 33 are coupled to each other via the bus 34. The input/output interface 35 is also coupled to the bus 34.

The input section 36, output section 37, storage 38, communicator 39, and media drive 40 are coupled to the input/output interface 35.

The input section 36 is composed of a keyboard, a mouse, a touchscreen, a microphone, and the like.

The output section 37 is composed of a display such as a liquid crystal display (LCD) or an organic electro luminescence (EL) panel, a loudspeaker, and the like.

The storage 38 is composed of a hard disk drive (HDD), a flash memory device, and the like. The storage 38 stores information about each vehicle 2 for rescuing the malfunctioning vehicle 2T.

The communicator 39 performs communication processing and device-to-device communication via a communication network.

The media drive 40 is equipped with semiconductor memory or removable media 41 such as magnetic disks, optical disks, and magneto-optical disks as necessary, and information is written to and read from the removable media 41.

In the server apparatus 1, data and programs are uploaded and downloaded through communication by the communicator 39. Moreover, data and programs can be transferred via the removable media 41.

As the CPU 31 performs processing operations based on various programs, information processing and communication necessary as the server apparatus 1 is executed.

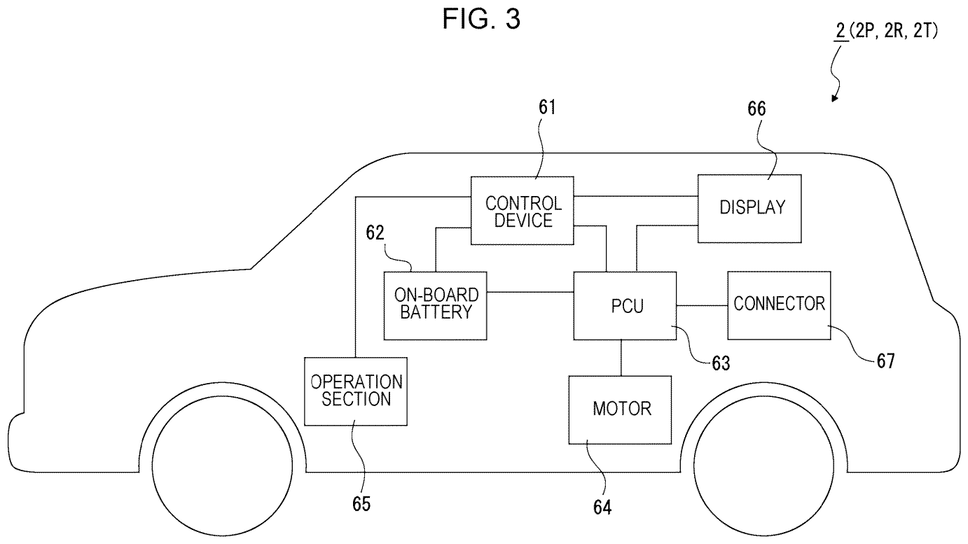

An example of the configuration of each vehicle 2 is illustrated in FIG. 3.

The vehicle 2 includes a control device 61, an on-board battery 62, a power control unit (PCU) 63, a motor 64, an operation section 65, a display 66, and a connector 67.

Note that FIG. 3 illustrates some of the configurations included in the vehicle 2, and the vehicle 2 appropriately includes a map locator, various sensors for driving, communication equipment, and the like, all of which are not illustrated.

The control device 61 is configured with a CPU, memory, and the like, and performs overall control of the vehicle 2. The control device 61 may be provided as a single unit or may be configured with multiple electronic control units (ECUs). The multiple ECUs may include, for example, a battery control ECU that performs charging control of the on-board battery 62, a display control ECU that performs display control for a display device (including a meter, etc.) included in the vehicle 2, an airbag control ECU, an air conditioning control ECU, and the like.

The control device 61 realizes various functions by executing various programs stored in the memory or the like.

Each function included in the control device 61 will be described again later.

The on-board battery 62 is described as a high-voltage battery used by the vehicle 2 to travel. The on-board battery 62 supplies the power used to drive the wheels, the power used to operate the air conditioning equipment of the vehicle 2, and the power used to operate other equipment. FIG. 3 illustrates the power supply used to drive the wheels from the on-board battery 62 as well as the power supply to the display 66, and illustrations of the power supply used for the operation of other parts are omitted.

The on-board battery 62 is charged based on a direct current (DC) voltage supplied from the PCU 63.

The on-board battery 62 supplies the PCU 63 with the power supply voltage for driving the motor 64.

The PCU 63 is configured with an inverter, a AC/DC converter, and the like for driving the motor 64.

The PCU 63 generates and supplies to the motor 64 an alternating current (AC) for driving the motor 64 based on the power supply voltage supplied as described above. The PCU 63 controls the torque of the motor 64 by controlling the AC. The PCU 63 may also have an energy efficiency optimization function utilizing regenerative energy by having a regenerative braking function.

The motor 64 is configured as a motor generator with a power generation function, and the motor 64 drives the wheels based on the supplied AC.

The operation section 65 includes, for example, operation elements such as various buttons and levers disposed in front of the driver's seat of the vehicle 2. In addition, a multi-function display (MFD) with a touchscreen function, a display of a navigation device, and the like may be included in the operation section 65.

The user of the malfunctioning vehicle 2T can notify the server apparatus 1 that his/her vehicle is the malfunctioning vehicle 2T and asks for its rescue by performing operations with the operation section 65.

The user of the malfunctioning vehicle 2T can also select one vehicle from among the potential rescue vehicles 2P presented by the server apparatus 1 and notify the server apparatus 1 by performing operations with the operation section 65.

Furthermore, the user of the rescue vehicle 2R selected from among the potential rescue vehicles 2P can select whether to accept a rescue request from the server apparatus 1 by performing operations with the operation section 65.

The display 66 is a comprehensive representation of, for example, an MFD installed in front of the driver, and other display devices for presenting information to the driver.

The display 66 performs display based on detection signals detected by various sensors included in the vehicle 2.

Various types of information such as the total distance traveled by the vehicle, outside temperature, instantaneous fuel consumption, etc. are displayed in the display 66 as appropriate.

In addition, map information and extracted route information can be displayed in the display 66.

The display 66 of the malfunctioning vehicle 2T performs, for example, menu display to request rescue or display to present the potential rescue vehicles 2P provided by the server apparatus 1.

Also, the display 66 of the rescue vehicle 2R performs display for selecting whether to accept a rescue request.

The connector 67 is provided with a structure into which a charging plug included in charging equipment installed at each home or station can be plugged in. The connector 67 outputs an AC voltage supplied via the plugged—in charging plug to the PCU 63. The PCU 63, which is provided with an AC/DC converter, supplies a DC voltage obtained by conversion using the AC/DC converter to the on-board battery 62 to charge the on-board battery 62.

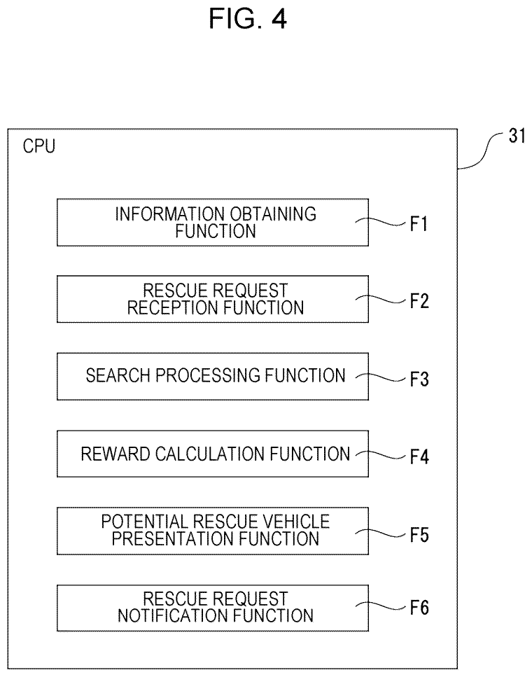

The CPU 31 of the server apparatus 1 realizes various functions by executing a program. An example of functions included in the CPU 31 in the present embodiment is illustrated in FIG. 4.

The CPU 31 includes an information obtaining function F1, a rescue request reception function F2, a search processing function F3, a reward calculation function F4, a potential rescue vehicle presentation function F5, and a rescue request notification function F6.

The information obtaining function F1 obtains information from the vehicles 2 which are under management thereof and updates the information periodically, for example.

The information obtained from each of the vehicles 2 by the information obtaining function F1 includes, for example, the current location information of the vehicle 2, information on the battery level of the on-board battery 62 included in the vehicle 2, charging cost information (a charging cost information set) pertaining to the power accumulated in the on-board battery 62, and the like.

The charging cost information is information indicating, for example, the cost taken to accumulate a charging amount of 1 kWh, and is information obtained at the vehicle 2. The charging cost information set may include the charging cost information.

In addition, the information obtaining function F1 may obtain a rescue record or the like for the vehicle 2. The rescue record information includes the date and time information when the rescue was performed, which is used to determine whether to request rescue according to the time when a malfunction occurred in another vehicle 2.

The rescue request reception function F2 is a function for receiving a rescue request sent from the malfunctioning vehicle 2T where a malfunction has occurred.

The rescue request reception function F2 realizes the processes of identifying the malfunctioning vehicle 2T based on information received from the malfunctioning vehicle 2T, identifying the current location of the malfunctioning vehicle 2T, identifying the malfunction content (rescue content), identifying the equipment necessary for resolving the malfunction, and the like.

The equipment necessary for resolving the malfunction includes cables for the on-board battery 62 of the malfunctioning vehicle 2T to receive charging from the on-board battery 62 of another vehicle 2 when the malfunctioning vehicle 2T is an electrically depleted vehicle, and towing equipment for towing the malfunctioning vehicle 2T from mud or the like when the malfunctioning vehicle 2T is a stuck vehicle that has become stuck in the mud or the like.

The search processing function F3 realizes the process of extracting other vehicles 2 suitable for rescuing the malfunctioning vehicle 2T, that is, the potential rescue vehicles 2P, in response to the rescue request reception function F2 receiving a rescue request. The search processing function F3 extracts the potential rescue vehicles 2P, for example, based on information on equipment necessary for resolving the malfunction and information on a distance traveled to the location of the malfunctioning vehicle 2T.

As an extraction condition for extracting the potential rescue vehicles 2P from among other vehicles 2, the search processing function F3 uses the location information of the malfunctioning vehicle 2T and the other vehicles 2, information on equipment necessary for resolving the malfunction (hereinafter simply described as “equipment information”), and charging cost information.

For example, the search processing function F3 extracts a vehicle 2 which is close to the malfunctioning vehicle 2T, which is equipped with the necessary equipment for resolving the malfunction, and which has an inexpensive charging cost as a potential rescue vehicle 2P.

Note that the search processing function F3 may use the time information necessary for merging with the malfunctioning vehicle 2T instead of the distance information. That is, the search processing function F3 may preferentially extract another vehicle 2 which is farther in distance but is likely to be able to merge smoothly as a potential rescue vehicle 2P, rather than another vehicle 2 which is closer in distance but is likely to get stuck in traffic jams.

The reward calculation function F4 realizes the process of calculating a reward to be paid to the rescuer rescuing the malfunctioning vehicle 2T. If there are multiple potential rescue vehicles 2P extracted by the search processing function F3, the reward calculation function F4 calculates a reward (payment amount) for each potential rescue vehicle 2P.

The reward calculated by the reward calculation function F4 includes, for example, the necessary expenses, which are the costs of the rescue, and the rescue compensation, which is the incentive paid for the rescue action.

The necessary expenses include the travel cost, which is the cost taken by the potential rescue vehicle 2P to merge with the current location of the malfunctioning vehicle 2T, and the rescue cost to get the malfunctioning vehicle 2T out of the current malfunction.

The travel cost is calculated from the travel power consumption, which is calculated based on the distance traveled and the energy efficiency, and the charging cost. In addition, if a toll road is used for merging, the toll is also included in the travel cost. Furthermore, the travel cost may include not only a one-way cost for the potential rescue vehicle 2P to merge with the current location of the malfunctioning vehicle 2T, but also a round-trip cost for the potential rescue vehicle 2P to return to its original location.

The rescue cost also includes, if the malfunctioning vehicle 2T is an electrically depleted vehicle, a battery usage fee calculated from the power consumed in the on-board battery 62 of the potential rescue vehicle 2P to charge the on-board battery 62 of the malfunctioning vehicle 2T, and the charging cost. The battery usage fee is obtained by multiplying the charging cost (cost per charge) and the power consumption.

The rescue cost also includes, if the malfunctioning vehicle 2T is a stuck vehicle, the cost calculated by multiplying the power consumed in towing the malfunctioning vehicle 2T out of the mud by the cost of receiving electricity.

If equipment is used for the rescue, an equipment usage fee and the like may be further included in the rescue cost.

The rescue compensation is further added to the necessary expenses and paid as a reward, which can motivate the rescuer's willingness to provide rescue.

The potential rescue vehicle presentation function F5 realizes the process of presenting the potential rescue vehicles 2P to the user of the malfunctioning vehicle 2T.

The rescue request notification function F6 realizes the process of identifying the vehicle 2 selected by the user of the malfunctioning vehicle 2T from among the potential rescue vehicles 2P as the rescue vehicle 2R and notifying the rescue vehicle 2R of a rescue request. The rescue request notification function F6 may also receive information as to whether the rescue request has been accepted by the rescue vehicle 2R to which the rescue request was made. If the rescue request is not accepted, the rescue request notification function F6 may cause the potential rescue vehicle presentation function F5 to perform the process of causing the user of the malfunctioning vehicle 2T to select another rescue vehicle 2R, or may cause the rescue search processing function F3 to perform the process of searching for the potential rescue vehicles 2P again.

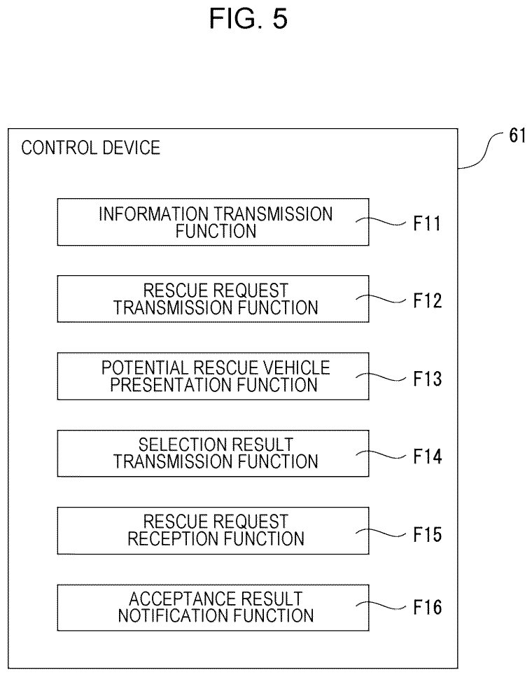

The control device 61 of each vehicle 2 realizes various functions by executing a program. An example of functions included in the control device 61 in the present embodiment is illustrated in FIG. 5.

The control device 61 of the vehicle 2 includes an information transmission function F11, a rescue request transmission function F12, a potential rescue vehicle presentation function F13, a selection result transmission function F14, a rescue request reception function F15, and an acceptance result notification function F16.

The information transmission function F11 is a function corresponding to the information obtaining function F1 on the server apparatus 1 side, and, in response to a request from the server apparatus 1, transmits the current location information of the vehicle 2, information on the battery level of the on-board battery 62 included in the vehicle 2, charging cost information pertaining to the power accumulated in the on-board battery 62, and the like.

The charging cost information transmitted to the server apparatus 1 may be, for example, input by the user of the vehicle 2, or obtained through communication between the equipment at the charging station and the vehicle 2 when charging the on-board battery 62 at the charging station, or through communication between the server terminal and the vehicle 2 via the equipment at the charging station.

In addition, when charging the on-board battery 62 using the charging outlet installed at home, charging cost information may be obtained through communication of the server terminal of a power company with which the vehicle 2 has a contract, or may be obtained by estimating charging cost information based on the time zone information in which charging is performed.

Note that, when charging the on-board battery 62 of the vehicle 2, the information transmission function F11 transmits the charging status of the on-board battery 62 or the charging cost of the on-board battery 62 to the server apparatus 1, even without a request from the server apparatus 1.

This allows the server apparatus 1 to keep the charging cost information of the vehicle 2 up to date. That is, this may allow the server apparatus 1 to receive a charging cost information set including the charging cost information from each vehicle 2.

The rescue request transmission function F12 realizes the process of, if the vehicle 2 becomes out of power or gets stuck in mud and becomes the malfunctioning vehicle 2T, transmitting a rescue request to the server apparatus 1 in response to operations of the user.

The potential rescue vehicle presentation function F13 realizes the process of presenting to the user the potential rescue vehicles 2P, which are transmitted from the server apparatus 1 after the rescue request is transmitted by the rescue request transmission function F12 to the server apparatus 1.

The selection result transmission function F14 realizes the process of transmitting to the server apparatus 1 a selection result made by the user from among the potential rescue vehicles 2P presented by the potential rescue vehicle presentation function F13.

The rescue request reception function F15 realizes, in the occurrence of the malfunctioning vehicle 2T other than the local vehicle, the process of receiving a rescue request transmitted from the server apparatus 1 in response to being selected by the user of the malfunctioning vehicle 2T as the rescue vehicle 2R for rescuing the malfunctioning vehicle 2T.

The rescue request reception function F15 not only notifies the user that the rescue request has been received from the server apparatus 1, but also presents to the user the current location of the malfunctioning vehicle 2T to be rescued, the travel time taken to reach it, the reward to be paid, information on the equipment necessary for the rescue, and the like. As a breakdown of the reward to be paid, necessary expenses and rescue compensation may be further presented.

The acceptance result notification function F16 realizes the process of notifying the server apparatus 1 of a selection result whether to accept the rescue request, which is chosen by the user in accordance with the information presented to the user by the rescue request reception function F15.

Note that, if the user is not near the vehicle 2 that has received the rescue request, or if there has been no user operation for a certain period of time after the reception of the rescue request, the acceptance result notification function F16 may automatically notify the server apparatus 1 of an acceptance result indicating that the rescue request is not accepted.

Examples of processes executed by the server apparatus 1 and the vehicle 2 will be described in accordance with the accompanying drawings.

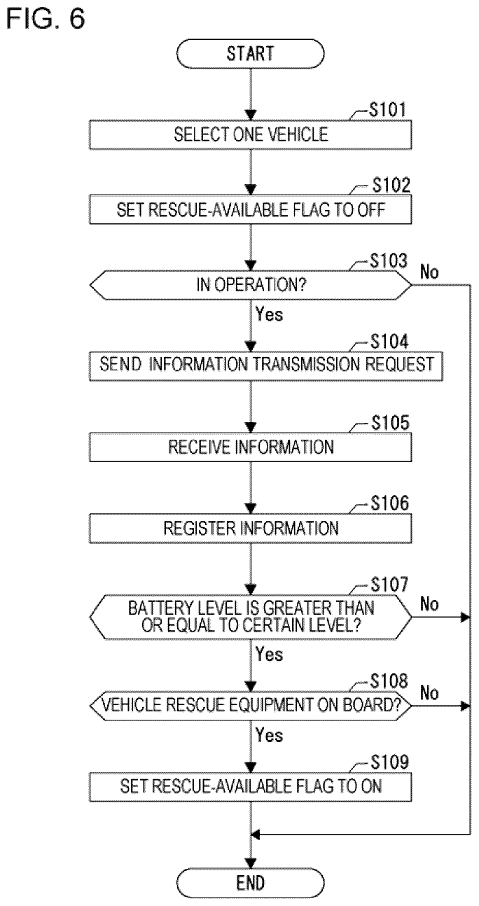

First, an example of a process for collecting information about a vehicle 2, which the server apparatus 1 executes periodically, is illustrated in FIG. 6.

The CPU 31 of the server apparatus 1 selects one vehicle 2 in step S101. This action involves selecting one vehicle 2 possessed by a user who has indicated his/her willingness to provide rescue for a malfunction occurring in another vehicle 2, and, for example, this is described as the action of selecting a vehicle 2 possessed by a user who utilizes the services offered by the server apparatus 1.

The one selected vehicle 2 here will be considered as the target vehicle 2 to be processed in the subsequent processing.

In step S102, the CPU 31 first sets the rescue-available flag for the target vehicle 2 to OFF. The rescue-available flag is a flag for identifying a vehicle 2 capable of providing rescue to another vehicle, and this flag is set to ON if, in the subsequent processing, it is determined that the target vehicle 2 can potentially serve as a rescue vehicle 2R.

In step S103, the CPU 31 determines whether the target vehicle 2 is in operation. Here, the vehicle 2 in operation is described as the vehicle 2 which is permitted to transmit information. For example, the vehicle 2 whose ignition is ON, the vehicle 2 which is currently being charged, the vehicle 2 which is currently traveling, etc. are applicable as the vehicle 2 in operation.

In contrast, the vehicle 2 which is not in a charging state and which is not traveling is considered to be the vehicle 2 which is not permitted to transmit information in order to avoid power consumption due to information transmission processing.

If it is determined that the target vehicle 2 is not in operation, the CPU 31 does not execute the processing from step S104 onward, and ends the process of the sequential actions illustrated in FIG. 6.

Note that the CPU 31 repeats the process of the sequential actions illustrated in FIG. 6. In one example, the CPU 31 repeats the action in step S101 to select another vehicle 2 as the target vehicle 2 to be processed, and performs the processing from step S102 onward.

If it is determined in step S103 that the target vehicle 2 is in operation, the CPU 31 transmits an information transmission request to the target vehicle 2 in step S104.

In response to this, the CPU 31 receives information from the target vehicle 2 in step S105.

The information received by the server apparatus 1 from the target vehicle 2 in step S105 is information including, for example, information on the battery level, the charging cost information described above, and information such as a vehicle chassis number and a vehicle identification number (VIN) for identifying the target vehicle 2.

In step S106, the CPU 31 registers (stores) the energy efficiency information of the target vehicle 2. The information registered here is not only the energy efficiency information, but also information indicating the charging cost information when charging 1 kWh (kilowatt per hour), the battery level, the chassis number, and the like, which are the information received in step S105.

In step S107, the CPU 31 determines whether the battery level of the target vehicle 2 is greater than or equal to a certain level. The vehicle 2 whose battery level is not greater than or equal to the certain level is not suitable as a potential rescue vehicle, and hence, the CPU 31 maintains the rescue-available flag for the target vehicle 2 as OFF and ends the process of the sequential actions illustrated in FIG. 6.

In contrast, if it is determined in step S107 that the battery level is greater than or equal to the certain level, the CPU 31 determines in step S108 whether the target vehicle 2 has the vehicle rescue equipment, which is equipment necessary for resolving the malfunction, such as the above-described cables and towing equipment, on board.

The information as to whether the target vehicle 2 has the vehicle rescue equipment on board is, for example, information received from the target vehicle 2 in the reception action in step S105.

If it is determined that the target vehicle 2 does not have the vehicle rescue equipment on board, the CPU 31 maintains the rescue-available flag for the target vehicle 2 as OFF and ends the process of the sequential actions illustrated in FIG. 6.

Note that, since the target vehicle 2, which is determined as NO in step S108, has a battery level capable of providing rescue, another flag may be set as a backup vehicle.

For example, if the malfunctioning vehicle 2T itself has the necessary rescue equipment on board, the rescue vehicle 2R need not have the vehicle rescue equipment on board. In that case, the potential rescue vehicle 2P or the rescue vehicle 2R may be selected from among the vehicles 2 as backup vehicles.

If it is determined in step S108 that the target vehicle 2 has the vehicle rescue equipment on board, the CPU 31 sets the rescue-available flag for the target vehicle 2 to ON in step S109.

Accordingly, the target vehicle 2 has the possibility of being selected as the potential rescue vehicle 2P.

Note that the rescue-available flag may be set for each piece of the vehicle rescue equipment.

For example, for a vehicle 2 that has cables on board but does not have towing equipment on board, the rescue-available flag for cables or electrically depleted vehicles is set to ON, and the rescue-available flag for towing equipment or stuck vehicles is set to OFF.

After finishing the action in step S109, the CPU 31 executes the action in step S101 again and selects another vehicle 2 as the target vehicle 2 to be processed.

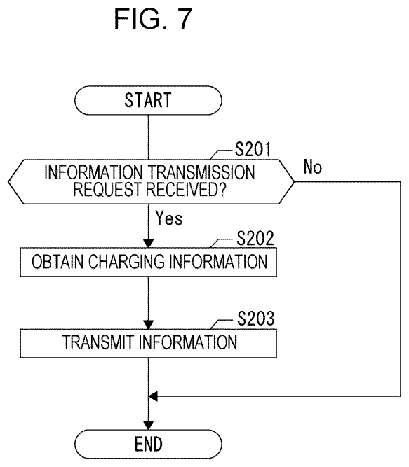

An example of a process executed by the control device 61 of the vehicle 2 in response to the CPU 31 of the server apparatus 1 executing the process illustrated in FIG. 6 is illustrated in FIG. 7.

In step S201, the control device 61 determines whether the information transmission request transmitted from the server apparatus 1 in step S104 of FIG. 6 has been received. If it is determined that it has not been received, the control device 61 ends the process of the sequential actions illustrated in FIG. 7.

In contrast, if it is determined in step S201 that the information transmission request has been received, the control device 61 obtains the charging information in step S202. The charging information obtained here includes information on the battery level and charging cost information.

The control device 61 then transmits the information to the server apparatus 1 in step S203 and ends the process of the sequential actions illustrated in FIG. 7.

The information transmitted in step S203 includes, in addition to the information obtained in step S202, information such as the chassis number and VIN for identifying the vehicle 2.

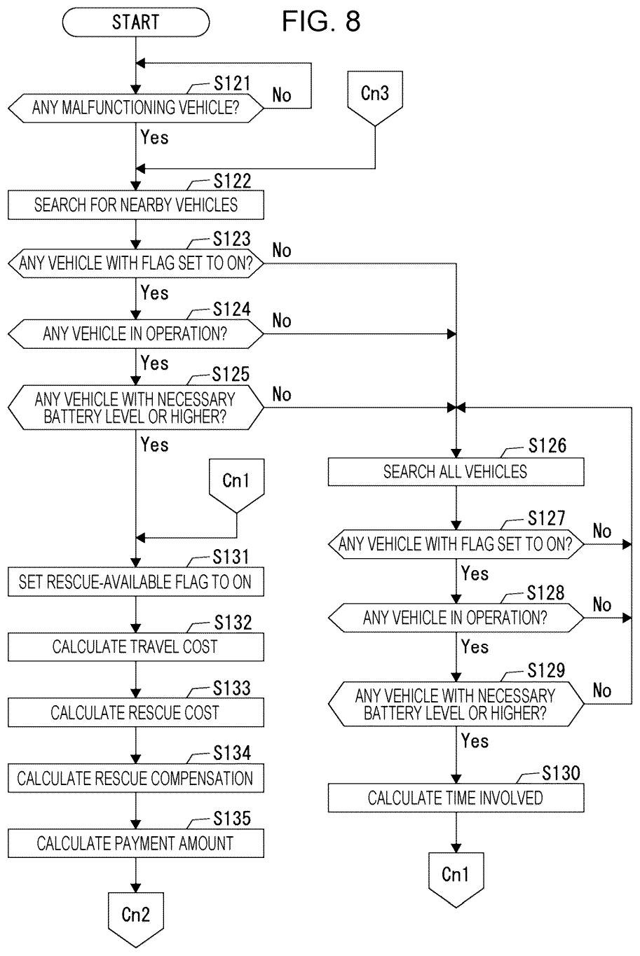

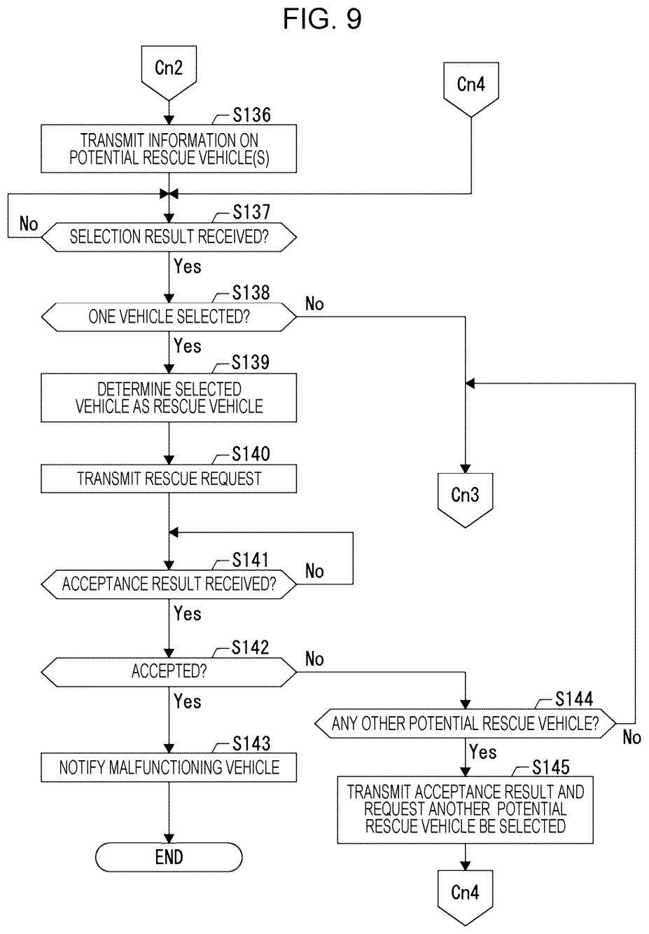

Examples of processes executed by the CPU 31 of the server apparatus 1 to resolve a malfunction occurring in the malfunctioning vehicle 2T will be described with reference to FIGS. 8 and 9. Note that connectors Cn1, Cn2, Cn3, and Cn4 in the drawings indicate connections between the processes.

In step S121 of FIG. 8, the CPU 31 determines whether there is a malfunctioning vehicle 2T. If there is no malfunctioning vehicle 2T, the CPU 31 repeats the action in step S121.

Note that, instead of performing the determination action in step S121 illustrated in FIG. 8, the CPU 31 may be configured to execute the actions from step S122 onward in response to a trigger which is the reception of a notification of the occurrence of a malfunction from the malfunctioning vehicle 2T.

If it is determined that there is a malfunctioning vehicle 2T, the CPU 31 searches for vehicles 2 located around the malfunctioning vehicle 2T in step S122. In this action, for example, it is permissible to search for vehicles 2 located closer than a certain distance to the malfunctioning vehicle 2T as nearby vehicles, or to search for vehicles 2 that can reach the current location of the malfunctioning vehicle 2T within a certain period of time as nearby vehicles.

In addition, if there is vehicle rescue equipment necessary for resolving the malfunction occurring in the malfunctioning vehicle 2T, the search action in step S122 is executed based on an additional condition that the target equipment is already on board.

Note that, if information indicating that the malfunctioning vehicle 2T itself has the target equipment on board is received from the malfunctioning vehicle 2T, the above-mentioned additional condition may be removed and the search action in step S122 may be executed.

In step S123, the CPU 31 determines whether there is a vehicle 2 with the rescue-available flag set to ON among the vehicles 2 extracted through the search action. Here, the vehicle 2 that is extracted through the search action and has its rescue-available flag set to ON is referred to as an “applicable vehicle”.

If it is determined in step S123 that there is no applicable vehicle, the CPU 31 proceeds to step S126 for a further search action. The details will be described later.

In contrast, if it is determined in step S123 that there is or are applicable vehicles, the CPU 31 determines in step S124 whether each applicable vehicle is in operation.

If it is determined in step S124 that there is no such applicable vehicle in operation, the CPU 31 proceeds to step S126 for a search action.

In contrast, if it is determined in step S124 that there is or are applicable vehicles in operation, the CPU 31 determines in step S125 whether there is an applicable vehicle whose battery level is greater than or equal to the necessary battery level.

If it is determined in step S125 that there is no applicable vehicle whose battery level is determined as greater than or equal to the necessary battery level, the CPU 31 proceeds to step S126 for a search action.

In contrast, if it is determined in step S125 that there is an applicable vehicle whose battery level is determined as greater than or equal to the necessary battery level, the CPU 31 executes the processing from step S131 onward to set the applicable vehicle as the potential rescue vehicle 2P and performs various actions.

Note that the action in step S125 may be executed as a shortlist action prior to extracting vehicles in steps S123 and S124.

For example, after executing a shortlist action based on the battery level in the action in step S125, the CPU 31 may check the rescue-available flag in step S123 and check whether each applicable vehicle is in operation in step S124.

As described above, the actions in steps S123, S124, and S125 are executable in any order.

The additional search action mentioned above will now be described.

If the action in step S123, S124, or S125 results in a NO determination, there is no vehicle 2 around the malfunctioning vehicle 2T to be preferentially selected as the potential rescue vehicle 2P.

In this case, the CPU 31 proceeds to step S126 and, as an additional search action, search all the vehicles 2.

In this action, for example, the search action is performed without narrowing down the candidates based on the location information of each vehicle 2. That is, the rescue-available flag is determined for each vehicle 2, and any vehicle 2 with the flag set to ON is extracted.

For the vehicles 2 extracted in step S126, the CPU 31 determines whether there is or are vehicles 2 with the rescue-available flag set to ON in step S127, determines whether the vehicle(s) 2 is/are in operation in step S128, and determines whether there is/are the vehicle(s) 2 whose battery level is determined as greater than or equal to the necessary battery level in step S129.

The action in step S127 is similar to the action in step S123 mentioned above, except that the target vehicles 2 being processed are different.

The action in step S128 is similar to the action in step S124 mentioned above, except that the target vehicles 2 being processed are different.

The action in step S129 is similar to the action in step S125 mentioned above, except that the target vehicles 2 being processed are different.

If any of the actions in steps S127, S128, and S129 results in a NO determination, the CPU 31 returns to the action in step S126 again.

Since the vehicles 2 extracted through the search action in step S126 can vary over time, the CPU 31 may execute the action in step S126 after a certain period of time has elapsed.

In contrast, if all the actions in steps S127, S128, and S129 result in a YES determination, the CPU 31 calculates the time involved in step S130, and then proceeds to step S131 to set the target vehicle 2 as the potential rescue vehicle 2P, and performs various actions.

The action in step S130 is the action of calculating the time taken by the target vehicle 2 to travel to the location of the malfunctioning vehicle 2T in a state capable of providing rescue.

For example, if the battery level is less than the necessary battery level, the time involved is calculated by adding the charging time involved in securing the necessary battery level and the travel time.

In addition, if the user of the vehicle 2 is away from the vehicle 2, the time involved is calculated by adding the time involved in the user picking up the vehicle 2 and the travel time of the vehicle 2.

In step S131, the CPU 31 sets the rescue-available flag to ON for the vehicle 2 determined as YES in the determination actions. This allows the CPU 31 to treat the target vehicle 2 as the potential rescue vehicle 2P in the subsequent processing. Note that there may be one potential rescue vehicle 2P, or multiple potential rescue vehicles 2P.

In step S132, the CPU 31 calculates the travel cost for each potential rescue vehicle 2P. The travel cost is calculated by taking into account the travel power consumption, charging cost, tolls, etc., as described above.

In step S133, The CPU 31 calculates the rescue cost for each potential rescue vehicle 2P. The rescue cost is calculated by taking into account the battery usage fee, equipment usage fee, etc., as described above.

In step S134, the CPU 31 calculates the rescue compensation for each potential rescue vehicle 2P. The rescue compensation may be a constant amount, or may be calculated by multiplying the travel cost and the rescue cost by a certain percentage. Furthermore, the rescue compensation may be calculated by applying a weighting based on the length of the travel distance and the duration of time constrained by the rescue operation.

In step S135, the CPU 31 calculates the payment amount for each potential rescue vehicle 2P. The payment amount is the total amount paid, which is obtained by adding up the travel cost, rescue cost, and rescue compensation.

After the action in step S135, the CPU 31 transmits information of the potential rescue vehicle(s) 2P to the malfunctioning vehicle 2T in step S136 of FIG. 9.

In step S137, the CPU 31 determines whether a selection result has been received from the malfunctioning vehicle 2T. The selection result is information identifying one potential rescue vehicle 2P selected by the user of the malfunctioning vehicle 2T from among one or more potential rescue vehicles 2P presented to the user of the malfunctioning vehicle 2T.

The selection result may be information indicating the result of selecting one potential rescue vehicle 2P or information indicating that none of the presented potential rescue vehicles 2P has been selected.

If it is determined in step S137 that the selection result has not been received, the CPU 31 repeats the action in step S137.

In contrast, if it is determined in step S137 that the selection result has been received, the CPU 31 determines in step S138 whether the received selection result is the selection of one potential rescue vehicle 2P.

If it is determined that the selection result is, for example, the selection result indicating that none of the potential rescue vehicles 2P has been selected, rather than the selection of one potential rescue vehicle 2P, the CPU 31 returns to the search action in step S122 of FIG. 8 and performs the action of extracting new potential rescue vehicles 2P.

In contrast, if it is determined that the selection result indicating that one potential rescue vehicle 2P has been selected has been received, the CPU 31 determines this potential rescue vehicle 2P as the rescue vehicle 2R in step S139.

In step S140, the CPU 31 transmits a rescue request to the rescue vehicle 2R.

At the rescue vehicle 2R having received the rescue request, the user selects whether to accept the rescue request. Then, the rescue vehicle 2R transmits a selection result made by the user to the server apparatus 1 as an acceptance result.

In addition, if the user does not perform a selection operation within a certain period of time, an acceptance result deemed that the user has chosen not to accept the rescue request is transmitted from the rescue vehicle 2R to the server apparatus 1.

In step S141, the CPU 31 checks whether the acceptance result has been received. The CPU 31 repeats the action in step S141 until the acceptance result is received.

If it is determined that the acceptance result has been received, the CPU 31 determines whether the rescue request has been accepted in step S142. If it is determined that the rescue request has been accepted, the CPU 31 notifies the malfunctioning vehicle 2T that the rescue vehicle 2R has been determined in step S143. In this notification action, the time taken by the rescue vehicle 2R to merge with the malfunctioning vehicle 2T, and the payment amount adding up the necessary expenses and the rescue compensation are presented again.

In contrast, if it is determined in step S142 that the user of the rescue vehicle 2R did not accept the rescue request, the CPU 31 determines in step S144 whether there are other potential rescue vehicles 2P.

For example, if multiple potential rescue vehicles 2P are presented to the user of the malfunctioning vehicle 2T and there is or are unselected potential rescue vehicles 2P among these potential rescue vehicles 2P, the CPU 31 determines in step S144 that there is or are other potential rescue vehicles 2P.

If it is determined that there is or are other potential rescue vehicles 2P, the CPU 31 transmits, in step S145, information indicating the acceptance result which is from the potential rescue vehicle 2P selected by the user and which indicates that the rescue request was not accepted to the malfunctioning vehicle 2T, as well as a notification to the malfunctioning vehicle 2T to request that another potential rescue vehicle 2P be selected from among the already presented potential rescue vehicles 2P.

In contrast, if it is determined in step S144 that there is no other potential rescue vehicle 2P, the CPU 31 returns to the search action in step S122 of FIG. 8 and performs the action of extracting new potential rescue vehicles 2P.

After finishing the action in step S143 or step S145, the CPU 31 ends the processing for the malfunctioning vehicle 2T. The CPU 31 then returns to the action in step S121 of FIG. 8 to determine whether there is another malfunctioning vehicle 2T.

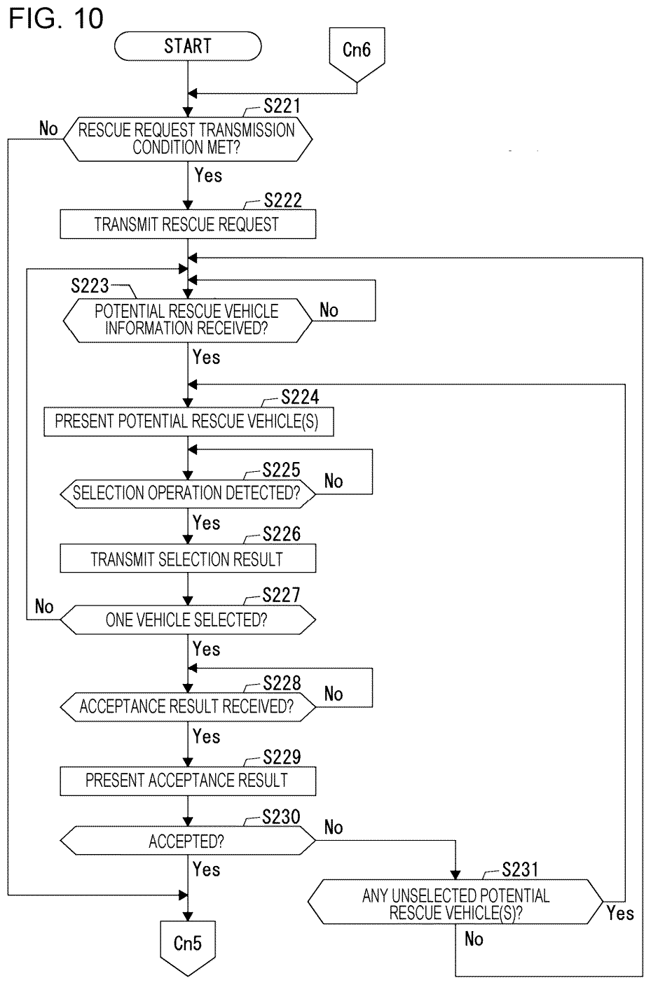

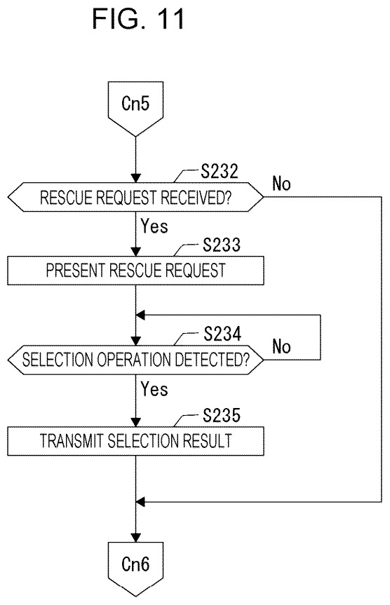

Examples of processes executed by the control device 61 of the malfunctioning vehicle 2T and of the potential rescue vehicle 2P in response to the processes illustrated in FIGS. 8 and 9 are illustrated in FIGS. 10 and 11.

Note that connectors Cn5 and Cn6 in the drawings indicate connections between the processes.

In step S221, the control device 61 determines whether a condition for transmitting a rescue request has been met. For example, if the user of a vehicle 2 has performed an operation for making a rescue request, it is determined that a condition for transmitting a rescue request has been met.

Alternatively, if a vehicle 2 becomes out of power and there is no charging station nearby, it may be automatically determined that a condition for transmitting a rescue request has been met.

If it is determined that the rescue request transmission condition has not been met, the control device 61 does not execute the remaining actions illustrated in FIG. 10, and proceeds to the process of FIG. 11.

If it is determined that the rescue request transmission condition has been met, the control device 61 transmits a rescue request to the server apparatus 1 in step S222. Note that, at the time point at which the action in step S222 is executed, the vehicle 2 is treated as a malfunctioning vehicle 2T for the server apparatus 1.

In step S223, the control device 61 determines whether information of the potential rescue vehicles 2P has been received from the server apparatus 1.

If it is determined that information of the potential rescue vehicles 2P has not been received, the control device 61 repeats the action in step S223.

In contrast, if it is determined in step S223 that information of the potential rescue vehicles 2P has been received, the control device 61 presents the potential rescue vehicles 2P to the user of the malfunctioning vehicle 2T in step S224.

In step S225, the control device 61 determines whether an operation to select one vehicle 2 from among the potential rescue vehicles 2P has been detected.

The control device 61 repeats the action in step S225 until the operation is detected.

If it is determined in step S225 that the selection operation has been detected, the control device 61 transmits the selection result in step S226.

Note that, if no selection operation performed by the user is detected for a certain period of time in the action in step S225, the control device 61 may transmit to the server apparatus 1 the selection result that none of the potential rescue vehicles 2P presented has been selected in step S226.

In step S227, the control device 61 performs processing that branches based on whether the user of the malfunctioning vehicle 2T has selected one vehicle 2 from among the potential rescue vehicles 2P.

For example, if the action in step S226 is executed without any potential rescue vehicle 2P being selected, the control device 61 determines in step S227 that no one potential rescue vehicle 2P has been selected, and returns to the action in step S223.

Accordingly, the control device 61 receives information of the potential rescue vehicles 2P again from the server apparatus 1 in step S223.

In contrast, if the action in step S227 is executed with one potential rescue vehicle 2P being selected, the control device 61 proceeds to step S228 to determine whether information indicating whether the user of the selected potential rescue vehicle 2P has accepted the rescue request has been received from the server apparatus 1. The control device 61 repeats the action in step S228 until the information is received.

If it is determined that information indicating whether the rescue request has been accepted has been received from the server apparatus 1, the control device 61 presents the acceptance result to the user of the malfunctioning vehicle 2T in step S229.

Subsequently, in step S230, the control device 61 performs processing that branches based on whether the rescue request has been accepted.

If it is determined that the rescue request has not been accepted, the control device 61 further determines whether there is or are unselected potential rescue vehicles 2P in step S231.

If it is determined that there is or are unselected potential rescue vehicles 2P, the control device 61 returns to step S224 and presents information of the potential rescue vehicle(s) 2P again to the user of the malfunctioning vehicle 2T.

In contrast, if it is determined that all of the presented potential rescue vehicles 2P have been selected, that is, if it is determined that the rescue request has been transmitted from the server apparatus 1 to all of the presented potential rescue vehicles 2P, the control device 61 returns to step S223 and waits until information of a new potential rescue vehicle 2P is received.

If it is determined in step S230 that the rescue request has been accepted, the control device 61 determines YES in step S230 and proceeds to step S232 in FIG. 11.

Note that the actions from step S232 onward are executed when it is determined whether the vehicle 2 has received a rescue request and the vehicle 2 has received a rescue request. However, the malfunctioning vehicle 2T determined as YES in step S221 is likely to be unable to respond to a rescue request.

Accordingly, the control device 61 after finishing the action in step S230 may be configured not to execute the process of the sequential actions illustrated in FIG. 11 until the malfunction of its own is resolved.

In step S232 of FIG. 11, the control device 61 determines whether a rescue request has been received. If the local vehicle as the potential rescue vehicle 2P considered as another vehicle 2 is selected for the malfunctioning vehicle 2T, a rescue request is transmitted from the server apparatus 1.

If it is determined that no rescue request has been received, the control device 61 does not execute the series of actions illustrated in FIG. 11, and returns to step S221 of FIG. 10 again.

In contrast, if it is determined that a rescue request has been received, the control device 61 presents the rescue request to the user of the local vehicle as the potential rescue vehicle 2P in step S233. In this presentation action, along with a notification indicating that the rescue request has been received, an operation element for whether to accept the rescue request may be presented.

In step S234, the control device 61 determines whether an operation to select whether to accept the rescue request has been detected.

The control device 61 repeats the action in step S234 until the operation is detected.

If it is determined that the control device 61 has detected an operation to select whether to accept the rescue request in step S234, the control device 61 transmits the selection result to the server apparatus 1 in step S235.

If no selection operation is detected for a certain period of time in step S234, the control device 61 may transmit the selection result indicating that the rescue request has not been accepted to the server apparatus 1 in step S235.

The above-described examples illustrate a configuration in which the server apparatus 1 and the control device 61 included in the vehicle 2 cooperate to realize the certain functions.

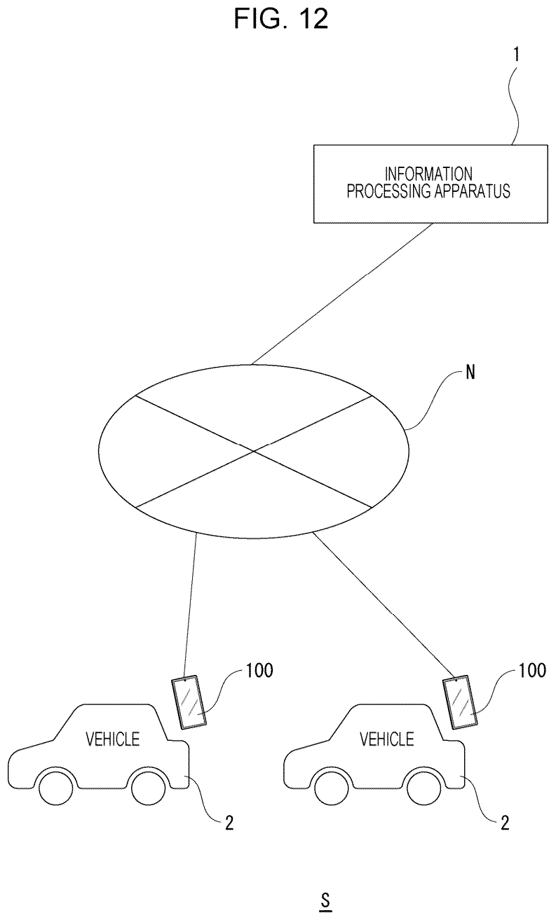

This is not the only possible case, and the application of the present technology may be realized through cooperation between the server apparatus 1 and a user terminal apparatus 100 such as a smartphone possessed by the user of the vehicle 2 (see FIG. 12).

Because the configuration of the user terminal apparatus 100 is as illustrated in FIG. 2, duplicate descriptions are avoided.

The CPU 31 of the user terminal apparatus 100 realizes each function illustrated in FIG. 5 by executing a program in place of the control device 61.

As the information transmission function F11, the CPU 31 of the user terminal apparatus 100 transmits the current location information of the vehicle 2, information on the battery level of the on-board battery 62 included in the vehicle 2, charging cost information pertaining to the power accumulated in the on-board battery 62, and the like.

At this time, as for the current location information, the current location of the user terminal apparatus 100 is simply obtained as alternative information and transmitted to the server apparatus 1.

In addition, information on the battery level and charging cost information of the on-board battery 62 of the vehicle 2 are obtained by the user entering information to the user terminal apparatus 100, or through communication between the user terminal apparatus 100 and the vehicle 2 and transmitted to the server apparatus 1.

Note that the charging cost information may be obtained by the user terminal apparatus 100 from the server terminal of the power company.

As the rescue request transmission function F12, the CPU 31 of the user terminal apparatus 100 detects a user operation for notifying a malfunction and transmits a rescue request to the server apparatus 1.

As the potential rescue vehicle presentation function F13, the CPU 31 of the user terminal apparatus 100 performs the action of presenting to the user the potential rescue vehicle(s) 2P transmitted from the server apparatus 1.

As the selection result transmission function F14, the CPU 31 of the user terminal apparatus 100 transmits to the server apparatus 1 a selection result based on a selection operation performed by the user of each of the potential rescue vehicle(s) 2P presented to the user.

As the rescue request reception function F15, the CPU 31 of the user terminal apparatus 100 receives a rescue request for the malfunctioning vehicle 2T other than the local vehicle from the server apparatus 1.

As the acceptance result notification function F16, the CPU 31 of the user terminal apparatus 100 notifies the server apparatus 1 of the result of the user operation in response to the rescue request as an acceptance result.

In this way, by using the CPU 31 of the user terminal apparatus 100, the above-described various processes can be realized without using the control device 61 of the vehicle 2.

The necessary expenses described in the above example may exceed expectations. For example, it is conceivable that the travel cost and tolls differ from those assumed when the planned travel route cannot be taken and a detour is made.

In order to cope with such a case, the server apparatus 1 may notify each user that the necessary expenses are merely an estimate. In addition, if the estimated necessary expenses are changed, the server apparatus 1 may notify each user of the new information each time.

Furthermore, if the travel route is changed, it is conceivable that the travel time will also increase.

Therefore, the rescue compensation may be changed in accordance with changes in the necessary expenses. In this case, it is preferable to present the changed payment amount to the user as appropriate.

An information processing apparatus as the server apparatus 1 described above includes one or more processors (e.g., CPU 31) and a storage medium (e.g., ROM 32, RAM 33, storage 38, removable media 41, etc.) on which a program executed by the one or more processors is stored, the program including one or more instructions, the one or more instructions causing the one or more processors to execute a process as follows.

That is, the one or more instructions cause the one or more processors (e.g., CPU 31) to execute: obtaining charging cost information pertaining to charging an on-board battery 62 of a vehicle for which information is obtained (vehicle 2) (steps S104 and S105); receiving a rescue request from a malfunctioning vehicle 2T in which a malfunction has occurred (step S121); extracting, based on rescue content pertaining to resolving the malfunction and a battery level of the on-board battery 62 of the vehicle for which information is obtained, a vehicle capable of resolving the malfunction from among vehicles for which information is obtained as a potential rescue vehicle 2P (steps S122 and S126); calculating a reward (at least rescue compensation) based on the rescue content and the charging cost information for each of the potential rescue vehicles 2P (steps S132, S133, S134, and S135); presenting each of the potential rescue vehicles 2P and the reward to a user of the malfunctioning vehicle 2T (step S136); identifying a vehicle 2 (potential rescue vehicle 2P) selected by the user of the malfunctioning vehicle 2T from among the potential rescue vehicles 2P as a rescue vehicle 2R (step S139); and notifying a user of the rescue vehicle 2R of a rescue request (step S140).

The cost of charging the on-board battery 62 installed in an electric vehicle (EV) or a hybrid electric vehicle (HEV) varies depending on the charging method.

In the information processing apparatus with the present configuration, appropriate rewards can be calculated by using the charging cost information.

This makes it possible to make highly appealing rescue requests to users who are willing to provide rescue. Therefore, it is possible to quickly resolve malfunctions that have occurred.

In addition, because appropriate rewards are calculated, the burden on rescuers can be reduced, and their willingness to provide rescue can be improved.

Furthermore, because rewards are presented in advance and mutual agreements are reached before the request for rescue is made, it is possible to avoid the occurrence of financial disputes.

In addition, by increasing the number of opportunities for the general public to get involved in rescue activities, specialized professionals become available more easily, thereby shortening the resolution time in the event of malfunctions that cannot be resolved except by specialized professionals.

In addition, it is conceivable that the information processing apparatus be provided with a mechanism for automatically paying an appropriate reward from the user of the malfunctioning vehicle 2T to the user of the rescue vehicle 2R. This makes it possible to avoid disputes at the time of payment of a reward and further motivate the willingness to provide rescue.

Although the above examples have been discussed with EVs and HEVs, the disclosure is applicable to vehicles 2 having an internal combustion engine, such as gasoline vehicles, as well as fuel cell vehicles. At this time, the travel cost may be calculated as the cost necessary to travel 1 km, for example.

In the information processing apparatus as the server apparatus 1 described above, the rescue content may include information on equipment necessary for the rescue and information on a distance traveled from a location of the vehicle for which information is obtained to a location of the malfunctioning vehicle 2T.

For example, if it is necessary to tow the vehicle to resolve the malfunction, the potential rescue vehicle 2P is extracted from among the vehicles 2 having towing equipment on board.

Accordingly, the rescue vehicle 2R selected from among the potential rescue vehicles 2P also has the necessary equipment for resolving the malfunction on board, thereby preventing wasteful travel to the location of the malfunctioning vehicle 2T without being able to resolve the malfunction.

In addition, since information on the distance traveled is included in the rescue content, the possibility that a vehicle involving long-distance travel is extracted as the potential rescue vehicle 2P is reduced, thereby preventing the time involved in resolving the malfunction from becoming longer.

In the information processing apparatus as the server apparatus 1 described above, the one or more instructions may cause the one or more processors (e.g., CPU 31) to execute, in a case where there is no potential rescue vehicle 2P extracted, relaxing an extraction condition used for the extraction and extracting the potential rescue vehicle 2P again (step S126).

For example, as the extraction condition, a threshold for the battery level may be relaxed, or even vehicles that are farther away from the malfunctioning vehicle 2T may be extracted.

Moreover, even vehicles that are estimated to arrive more slowly at the location of the malfunctioning vehicle 2T may be extracted.

This may improve the likelihood of resolution of the malfunction in the malfunctioning vehicle 2T.

In the information processing apparatus as the server apparatus 1 described above, the one or more instructions may cause the one or more processors (e.g., CPU 31) to execute extracting the potential rescue vehicle 2P after executing a shortlist action based on the battery level.

If all of vehicles for which information is obtained are subjected to determination as to whether to be selected as the potential rescue vehicle 2P, the processing time and processing burden will increase.

With the present configuration to first execute a shortlist action based on the battery level, the processing burden and processing time pertaining to the extraction determination can be reduced.

The information processing system S described above is the information processing system S including a first information processing apparatus on a server side (server apparatus 1) and a second information processing apparatus (vehicle 2 or user terminal apparatus 100) associated with a vehicle, the first information processing apparatus including one or more first processors (e.g., CPU 31 of the server apparatus 1) and a first storage medium (e.g., ROM 32, RAM 33, storage 38, removable media 41, etc. of the server apparatus 1) on which a first program executed by the one or more first processors is stored, the first program including one or more first instructions, the one or more first instructions causing the one or more first processors to execute a process as follows.

That is, the one or more first instructions cause the one or more first processors (e.g., CPU 31 of the server apparatus 1) to execute: obtaining, from the second information processing apparatus, charging cost information pertaining to charging an on-board battery 62 of a vehicle for which information is obtained (vehicle 2) (steps S104 and S105); receiving a rescue request from a malfunctioning vehicle 2T in which a malfunction has occurred (step S121); extracting, based on rescue content pertaining to resolving the malfunction and a battery level of the on-board battery 62 of the vehicle for which information is obtained, a vehicle capable of resolving the malfunction from among vehicles for which information is obtained as a potential rescue vehicle 2P (steps S122 and S126); calculating a reward (at least rescue compensation) based on the rescue content and the charging cost information for each of the potential rescue vehicles 2P (steps S132, S133, S134, and S135); presenting each of the potential rescue vehicles 2P and the reward to a user of the malfunctioning vehicle 2T (step S136); identifying a vehicle 2 (potential rescue vehicle 2P) selected by the user of the malfunctioning vehicle 2T from among the potential rescue vehicles 2P as a rescue vehicle 2R (step S139); and notifying a user of the rescue vehicle 2R of a rescue request (step S140).

Furthermore, the second information processing apparatus (vehicle 2 or user terminal apparatus 100) includes one or more second processors (e.g., control device 61 of the vehicle 2 or CPU 31 of the user terminal apparatus 100) and a second storage medium (e.g., memory of the control device 61 of the vehicle 2 or ROM 32, RAM 33, storage 38, removable media 41, etc., of the user terminal apparatus 100) on which a second program executed by the one or more second processors is stored, the second program including one or more second instructions, the one or more second instructions causing the one or more second processors to execute a process as follows.

That is, the one or more second instructions cause the one or more second processors (e.g., control device 61 of the vehicle 2 or CPU 31 of the user terminal apparatus 100) to execute: transmitting the charging cost information pertaining to charging the on-board battery 62 of the associated vehicle 2 to the first information processing apparatus (server apparatus 1) (step S203); determining whether a malfunction has occurred in the associated vehicle 2 (step S221); notifying the first information processing apparatus when it is determined that a malfunction has occurred (step S222); displaying each of the potential rescue vehicles 2P extracted by the first information processing apparatus and the reward (step S224); transmitting information for identifying a vehicle selected from among the potential rescue vehicles 2P to the first information processing apparatus (step S226); receiving the rescue request from the first information processing apparatus (step S232); and performing display in accordance with reception of the rescue request (step S233).

With the information processing system S as described above, various operations and effects described above can also be achieved.

Embodiments and modifications described above can be combined as appropriate.

According to the disclosure, appropriate rewards can be presented to rescuers.

The CPU 31 of the server apparatus 1 and of the user terminal apparatus 100 illustrated in FIG. 4 and the control device 61 of the vehicle 2 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the information obtaining function F1, the rescue request reception function F2, the search processing function F3, the reward calculation function F4, the potential rescue vehicle presentation function F5, and the rescue request notification function F6, as well as the information transmission function F11, the rescue request transmission function F12, the potential rescue vehicle presentation function F13, the selection result transmission function F14, the rescue request reception function F15, and the acceptance result notification function F16. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 4 and in FIG. 5.

1. An information processing apparatus comprising:
one or more processors; and
a storage medium on which a program to be executed by the one or more processors is stored,
the program comprising one or more instructions,
the one or more instructions causing the one or more processors to execute:
obtaining charging cost information sets pertaining to charging on-board batteries of vehicles;
receiving a rescue request from a malfunctioning vehicle in which a malfunction has occurred;
extracting, based on rescue content pertaining to resolving the malfunction and battery levels of the on-board batteries of the vehicles, one or more vehicles capable of resolving the malfunction as one or more potential rescue vehicles from among the vehicles;
calculating a reward based on the rescue content and corresponding one or more of the charging cost information sets for each of the one or more potential rescue vehicles;
presenting each of the one or more potential rescue vehicles and the reward to a user of the malfunctioning vehicle;
identifying a vehicle selected by the user of the malfunctioning vehicle from among the one or more potential rescue vehicles as a rescue vehicle; and
notifying a user of the rescue vehicle of a rescue request.

2. The information processing apparatus according to claim 1, wherein
the rescue content includes information on equipment necessary for rescuing the malfunctioning vehicle and information on a distance traveled from a location of each of the vehicles for each of which the information is obtained to a location of the malfunctioning vehicle.

3. The information processing apparatus according to claim 2, wherein
the one or more instructions cause the one or more processors to execute:
in a case where there is no potential rescue vehicle extracted, relaxing an extraction condition used for the extracting the one or more potential rescue vehicles and extracting the one or more potential rescue vehicles again.

4. The information processing apparatus according to claim 1, wherein
the one or more instructions cause the one or more processors to execute:
extracting the one or more potential rescue vehicles after executing a shortlist action based on the battery levels.

5. The information processing apparatus according to claim 2, wherein
the one or more instructions cause the one or more processors to execute:
extracting the one or more potential rescue vehicles after executing a shortlist action based on the battery levels.

6. The information processing apparatus according to claim 3, wherein
the one or more instructions cause the one or more processors to execute:
extracting the one or more potential rescue vehicles after executing a shortlist action based on the battery levels.

7. The information processing apparatus according to claim 4, wherein
the one or more instructions cause the one or more processors to execute:
extracting the one or more potential rescue vehicles after executing a shortlist action based on the battery levels.

8. An information processing system comprising:
a first information processing apparatus on a server side; and
a second information processing apparatus associated with a vehicle,
the first information processing apparatus comprising:
one or more first processors; and
a first storage medium on which a first program to be executed by the one or more first processors is stored,
the first program comprising one or more first instructions,
the one or more first instructions causing the one or more first processors to execute:
obtaining, from the second information processing apparatus, charging cost information sets pertaining to charging on-board batteries of vehicles;
receiving a rescue request from a malfunctioning vehicle in which a malfunction has occurred;
extracting, based on rescue content pertaining to resolving the malfunction and battery levels of the on-board batteries of the vehicles, one or more vehicles capable of resolving the malfunction as one or more potential rescue vehicles from among the vehicles;
calculating a reward based on the rescue content and corresponding one or more of the charging cost information sets for each of the one or more potential rescue vehicles;
presenting each of the one or more potential rescue vehicles and the reward to a user of the malfunctioning vehicle;
identifying a vehicle selected by the user of the malfunctioning vehicle from among the one or more potential rescue vehicles as a rescue vehicle; and
notifying a user of the rescue vehicle of a rescue request,
the second information processing apparatus comprising:
one or more second processors; and
a second storage medium on which a second program to be executed by the one or more second processors is stored,
the second program comprising one or more second instructions,
the one or more second instructions causing the one or more second processors to execute:
transmitting the charging cost information pertaining to charging the on-board battery of the associated vehicle to the first information processing apparatus;
determining whether a malfunction has occurred in the associated vehicle;
notifying the first information processing apparatus when it is determined that the malfunction has occurred;
displaying each of the one or more potential rescue vehicles extracted by the first information processing apparatus and the reward;
transmitting information for identifying a vehicle selected from among the one or more potential rescue vehicles to the first information processing apparatus;
receiving the rescue request from the first information processing apparatus; and
performing display in accordance with reception of the rescue request.
